(19) United States
(12) Patent Application Publication
(10) Pub. No.: US 2017/0104265 A1
(43) Pub. Date: Apr. 13, 2017

(54) GROUND PHASE MANIPULATION IN A BEAM FORMING ANTENNA

(71) Applicant: NOKIA SOLUTIONS AND NETWORKS OY, Espoo (FI)

(72) Inventor: Juha Samuel HALLIVUORI, Tampere (FI)

(21) Appl. No.: 14/878,622

(22) Filed: Oct. 8, 2015

(51) Int. Cl. H01Q 1/48; H01Q 9/04

(52) U.S. Cl. CPC H01Q 1/48; H01Q 9/0407

(57) ABSTRACT

Various radio frequency propagating antennas may benefit from an improved structure to allow for a better beam forming. For example, beam forming antennas may benefit from a beam steering structure involving at least one resonator. According to certain embodiments, an apparatus includes at least two radiating elements, and at least two ground planes attached to the at least two radiating elements. The apparatus also includes at least one resonator, where the at least one resonator is connected between the at least two ground planes.

### BACKGROUND

Field

Various radio frequency propagating antennas may benefit from an improved structure to allow for better beamforming. For example, beam forming antennas may benefit from a beam steering structure involving at least one resonator.

Description of the Related Art

Beamforming is a signaling technique used for the directional steering of signals toward a receiver. Generally, beamforming utilizes a phased array of antennas in which individual antennas emit a signal with a relative phase. The propagated signals then experience either constructive interference or destructive interference with each other. Such interference can be used to affect the radiation pattern propagated by the array, and adjust the phase and/or amplitude of the signal at a given location. Beamforming may therefore be used to improve the realized gain of a propagated signal at a given location.

Beamforming can be utilized in a digital, analog, or hybrid domain. Analog beamforming is based on the signal phase relation between the unity antenna cells inside the phased array. In digital beamforming, the phase and amplitude tuning is done in the baseband. The baseband is a low frequency signal which is converted to a higher frequency radio frequency signal (RF) during propagation of the signal. In addition, in digital beamforming the antenna itself has as many RF connections to the radio as there are elements in the antenna.

When the analog beamforming array size is increased, meaning that the distance between the desired feed point and the individual cells is increased, the array signaling experiences ground signals phase anomalies and signal losses relative to single RF feeding point. This directly causes the beamforming accuracy to decrease, making it harder to manipulate the radiation pattern to maximize gain at a given point.

One way to improve the accuracy of beamforming would be to increase the ground plane at the ground side of the signal. This solution, however, is both expensive and inefficient. There is a need for a simplified and cheap construction of an antenna for accurate beamforming without the need of a beamforming support or beamforming array at the radio.

### SUMMARY

According to certain embodiments, an apparatus can include at least two radiating elements, and at least two ground planes dedicated to the at least two radiating elements. The apparatus can also include at least one resonator, where the at least one resonator is connected between the at least two ground planes.

### BRIEF DESCRIPTION OF THE DRAWINGS

For proper understanding of the invention, reference should be made to the accompanying drawings, wherein:

FIG. 1 illustrates a top view of an apparatus according to certain embodiments.

FIG. 2 illustrates a chart of the radiation pattern according to certain embodiments.

FIG. 3 illustrates a graph of a three dimensional gain according to certain embodiments.

FIG. 4 illustrates a chart of polarization values according to certain embodiments.

FIG. 5 illustrates a top view of an apparatus according to certain embodiments.

FIG. 6 illustrates a chart of the radiation pattern according to certain embodiments.

FIG. 7 illustrates a graph of a three dimensional gain according to certain embodiments.

FIG. 8 illustrates a chart of polarization values according to certain embodiments.

FIG. 9 illustrates a top view of an apparatus according to certain embodiments.

FIG. 10 illustrates a chart of the radiation pattern according to certain embodiments.

FIG. 11 illustrates a graph of a three dimensional gain according to certain embodiments.

FIG. 12 illustrates a chart of polarization values according to certain embodiments.

FIG. 13 illustrates a top view of an apparatus according to certain embodiments.

FIG. 14 illustrates a top view of an apparatus according to certain embodiments.

FIG. 15 illustrates a top view of an apparatus according to certain embodiments.

FIG. 16 illustrates a top view of an apparatus according to certain embodiments.

FIG. 17 illustrates a certain embodiment of a method of manufacturing an antenna.

### DETAILED DESCRIPTION

There is a need for a cheap beam steering structure that is capable of realizing an improved gain for a given direction. Rather than the phase array based steering, used in traditional beamforming, certain embodiments of the present invention may tune the phase and/or amplitude of the propagated ground signal in the printed circuit board of an antenna. In digital beamforming, antennas have as many radio frequency connections to the radio as there are elements in the antenna. In certain embodiments of the present invention, however, the antenna only uses one radio frequency connection for one polarization. This simplifies the structure of the antenna and efficiently decreases manufacturing costs of the antenna.

In addition, certain embodiments allow for a beamforming antenna unity cell with individual phase controlled ground sections. The individual phase control is achieved with the use of at least one resonator between the ground planes. The individual signal phases of the ground planes can then be manipulated to optimize beamforming in the multi cell analog array antennas. In certain other embodiments, the amplitude of the propagated ground signal, rather than the phase, may be manipulated to optimize beamforming in the antenna.

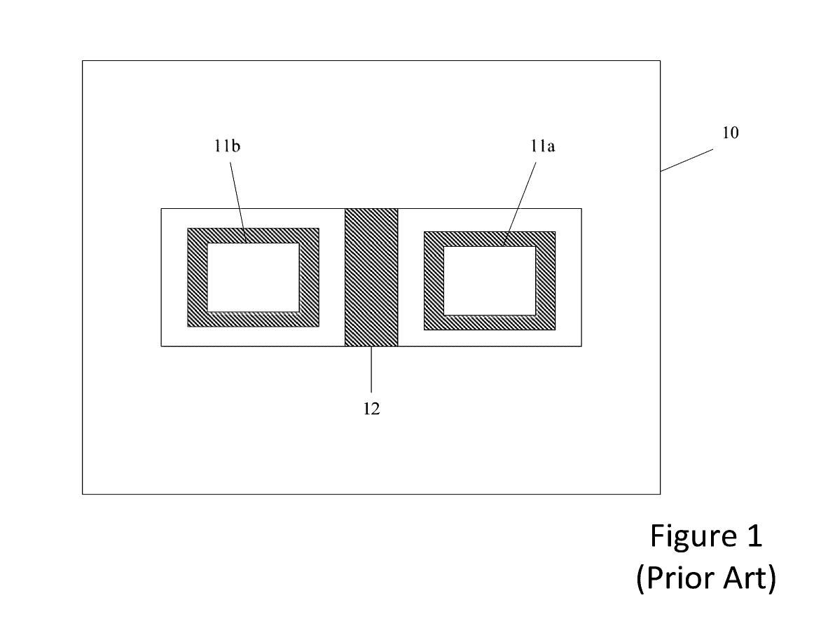

FIG. 1 illustrates a traditional analog microstrip or patch antenna. The antenna may include a printed circuit board 10; a substrate of the printed circuit board makes up the path antenna's dielectric. The antenna may also include at least two patch antennas 11a, 11b. Patch antennas 11a, 11b may be the radiating elements of the antenna.

As can be seen in the embodiment of FIG. 1, the patch antenna is placed over and connected to a ground plane 12. The ground plane is an electrically conductive surface places on the printed circuit board. In addition, the ground plane is connected to the power supply ground terminal (not shown in the figures). The distance between the patch and the ground plane can determine the bandwidth of the ground signal propagated by the patch antenna.

In the embodiment of FIG. 1, patch antennas 11a and 11b each radiate an analog signal. The radiating signals that are formed by the patch antenna 11a and 11b interfere with each other, leading to beamforming of the radiating signals.

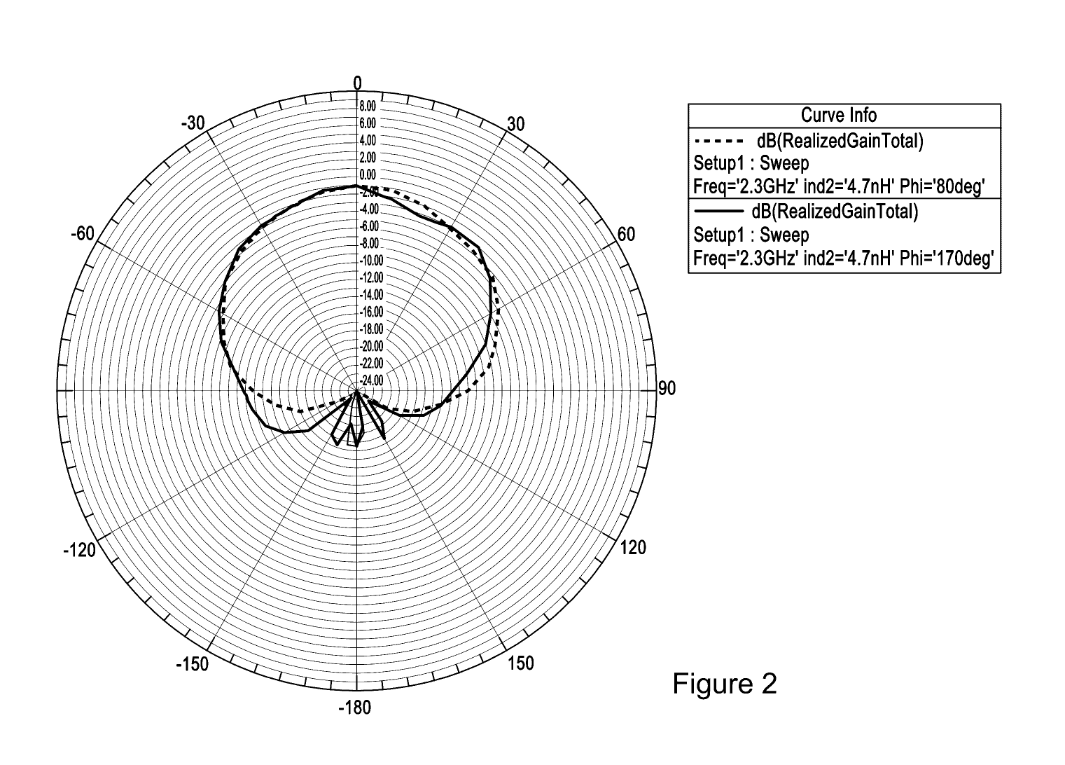

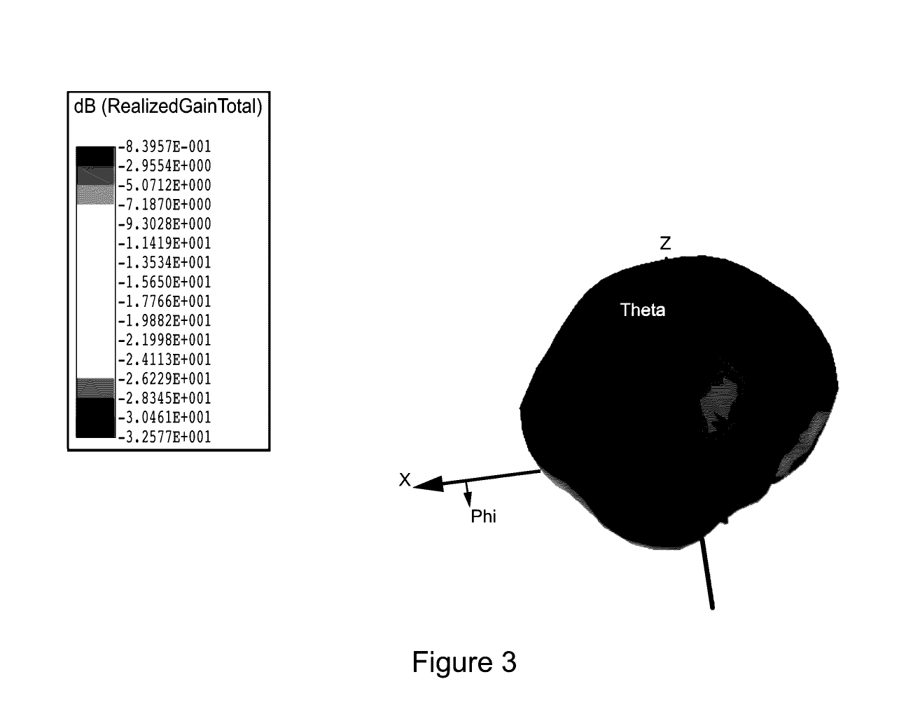

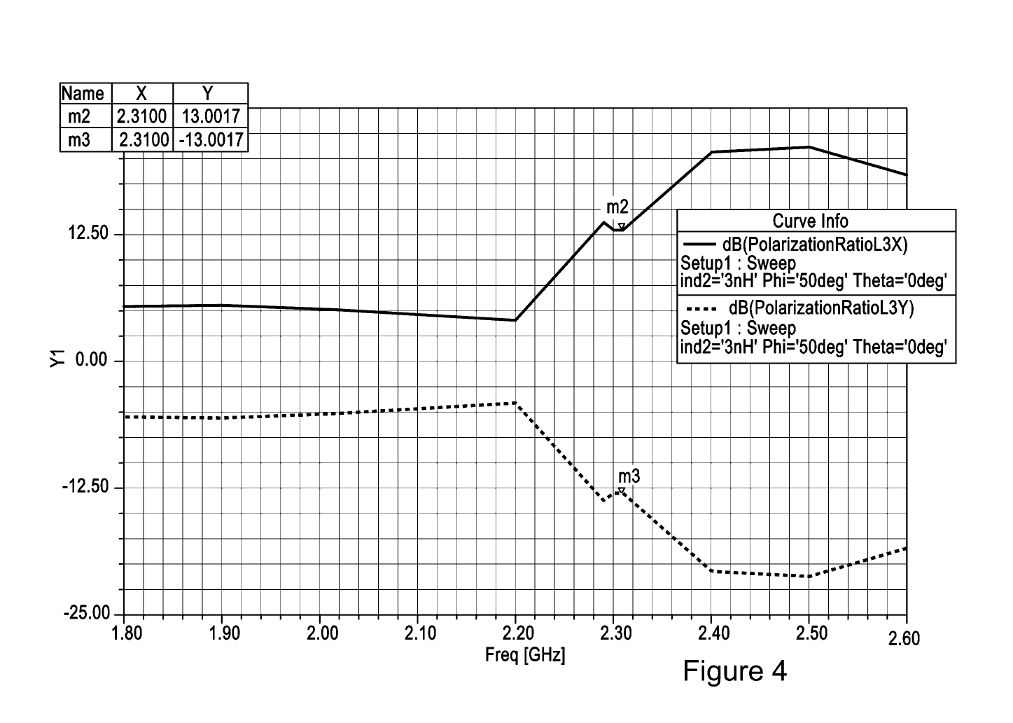

FIGS. 2 and 3 represent the realized gain total of the embodiment of the patch antenna of FIG. 1. Gain is a signal measurement that accounts for both the radiation efficiency and the directivity of an emitted signal. Radiation efficiency represents the ratio of how much of the total power driven into the antenna is then propagated out into space as a signal. Directivity, on the other hand, is a measurement of the power density the antenna radiates in the direction of its strongest emission. Further, FIG. 4 represents the polarization of the embodiment of the patch antenna of FIG. 1. Polarization refers to the orientation of the electric field of the radio wave with respect to the Earth's surface.

In FIGS. 2, 3, and 4, the signal phase is defined in the source and set to be zero degrees. As can be seen in FIG. 2, the total gain of the embodiment of FIG. 1 is just under −1.00 dBi. FIG. 3 lists the total gain of this embodiment to be around −0.084 dBi. FIG. 4 illustrates that the polarization of the beam radiated from the antenna of FIG. 1 is −13 dBs.

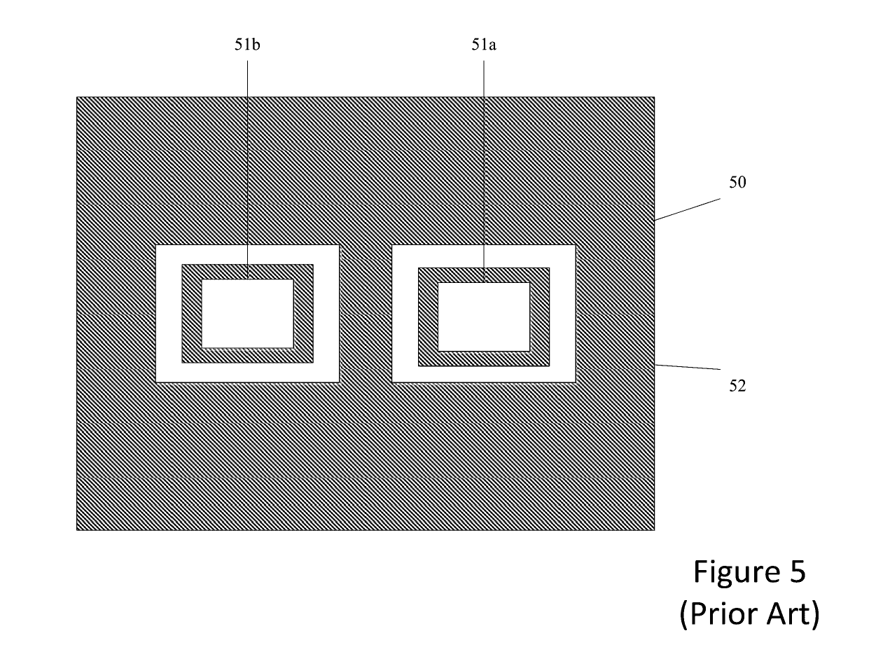

One way of improving the total gain of the patch antenna is to increase the size or surface area of the ground plane. The thickness of the ground plane may be also be changed to improve the total gain, particularly if the thickness is made to be very small. Such a change, however, would only have a minor effect on the propagated signal. FIG. 5 illustrated an embodiment of an analog antenna where the size of the ground plane has been increased. The antenna includes a printed circuit board 50 and a ground plane 52, which may be the same size as the printed circuit board 50. The antenna also includes two patch antennas 51a, 51b. The total gain may vary depending on the selected size in width and length of patch antennas 51a, 51b. This is the case because the width and length of the patch antenna will determine the frequency of operation, which can affect the total gain of the antenna. In comparison to ground plane 12, in FIG. 1, ground plane 52, in FIG. 5, has a greater surface area and encompasses a larger surface area of the printed circuit board. Even when ground plane 52 is at its largest, meaning that it spans the entire surface of printed circuit board 50, the realized total gain of antenna in FIG. 5 is far from optimal.

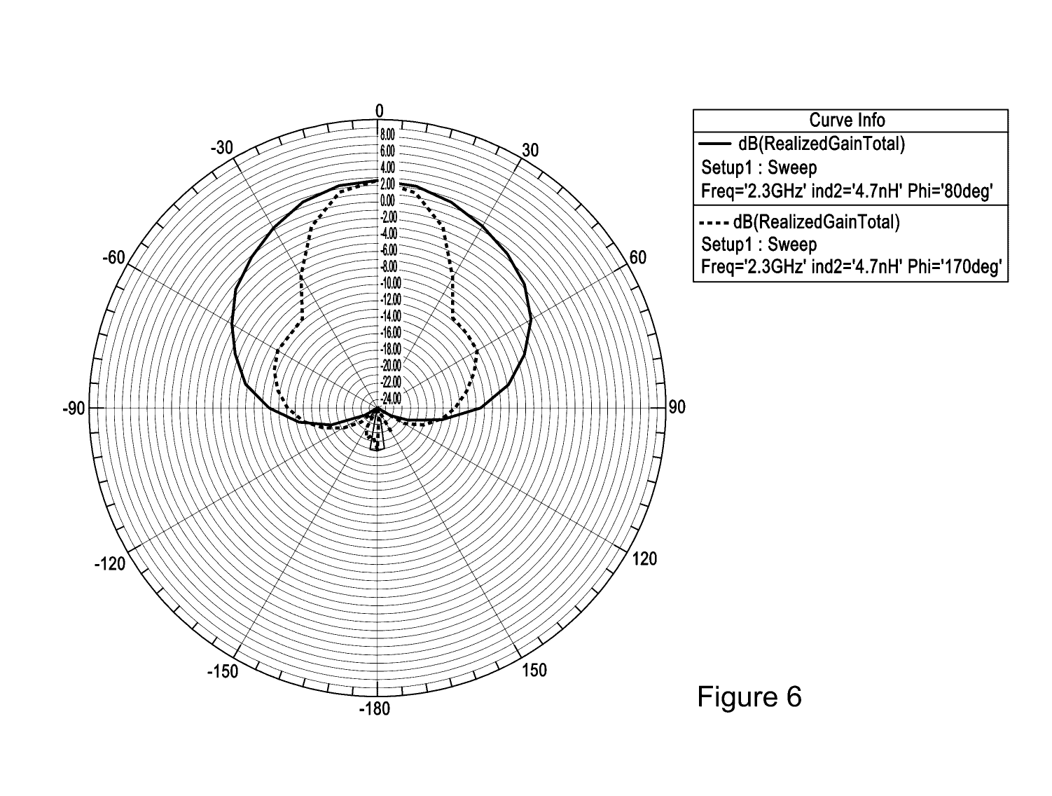

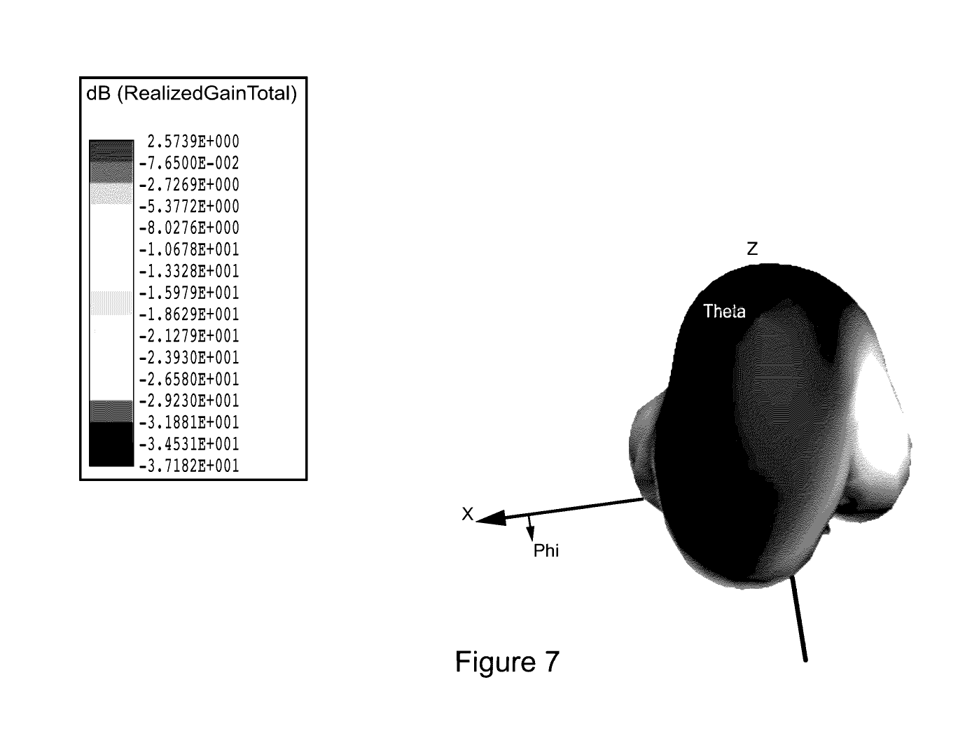

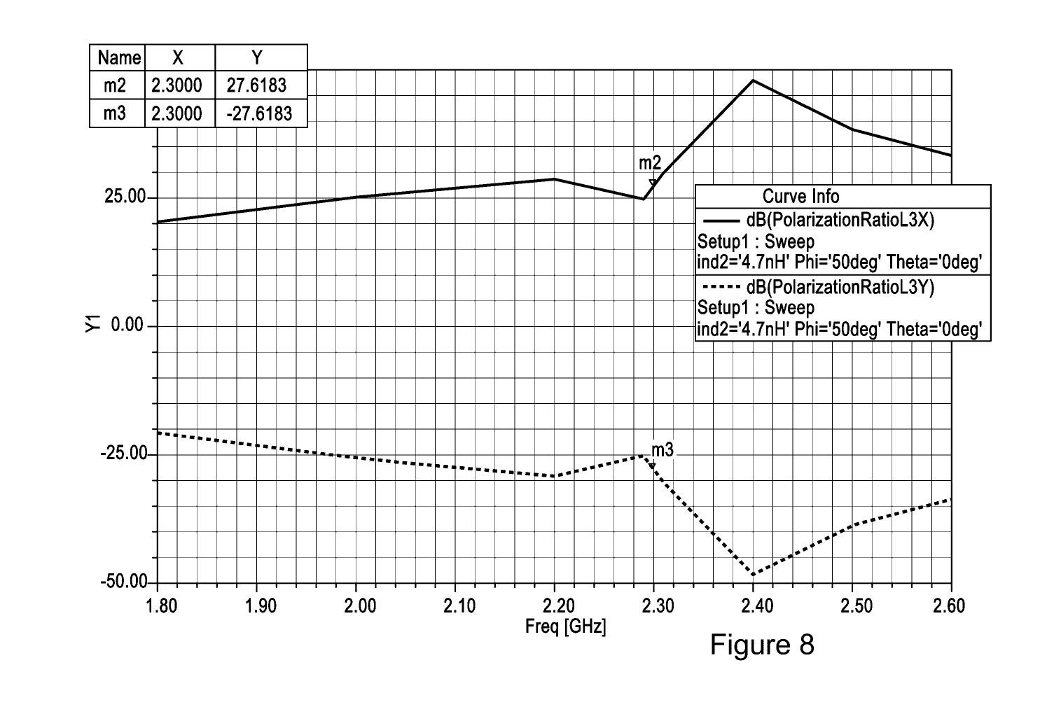

FIGS. 6 and 7 illustrate the total realized gain of the embodiment of the antenna described in FIG. 5. FIG. 8 represents the polarization of the embodiment of the patch antenna of FIG. 5. In FIGS. 6, 7, and 8 the signal phase is defined in the source and set to be zero degrees. As can be seen in FIG. 6, the total gain of this embodiment is just under 3.00 dBi. FIG. 7 lists the total gain of this embodiment to be around 2.57 dBi. FIG. 8 illustrates that the polarization of the beam radiated from the antenna of FIG. 5 is −27 dBs. Although the total gain and the polarization of the antenna have improved from the antenna embodied in FIG. 1, doing so requires a large and costly increase in the size of the plane ground. In effect, to achieve the improved signal propagation, the entirety of printed circuit board 50 needs to be covered by ground plane 52.

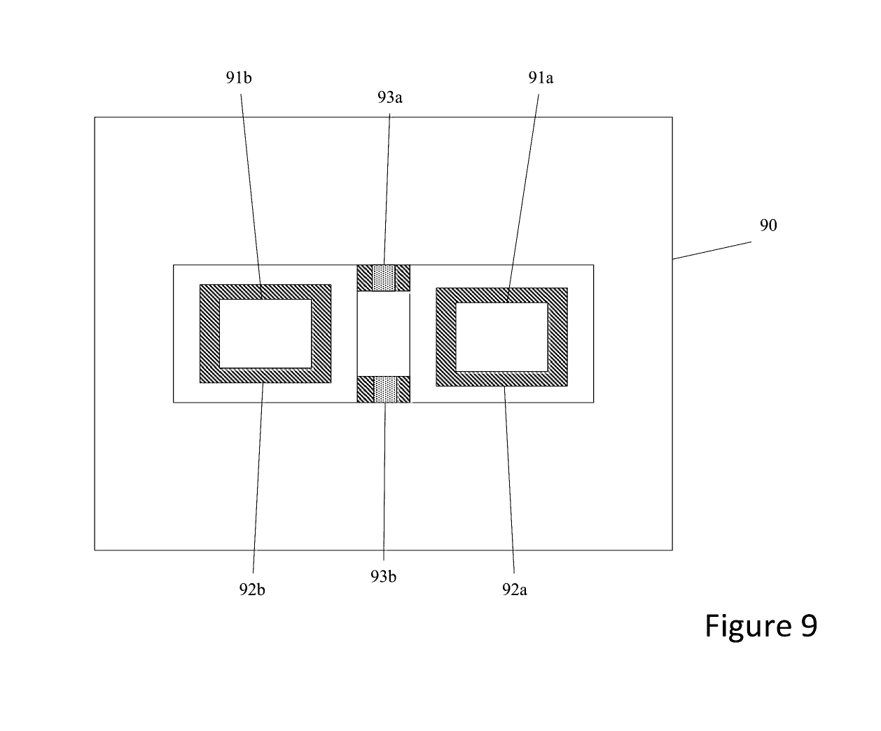

FIG. 9 illustrates a certain embodiment of the analog antenna according to the present invention. In some other embodiments, the antenna can be any type of single ended antenna. Some examples of such antennas include an Adcock antenna, AS-2259 Antenna, AWX antenna, Beverage antenna, Cantenna, Cassegrain antenna, Collinear antenna array, Conformal antenna, Corner reflector antenna, Curtain array, Doublet antenna, Folded inverted conformal antenna, Fractal antenna G5RV antenna, Gizmotchy, Helical antenna, Horn antenna, Inverted vee antenna, Log-periodic antenna, Loop antenna, Microstrip antenna, Offset dish antenna, Patch antenna, Phased array, Planar array, Parabolic antenna, Plasma antenna, Quad antenna, Reflective array antenna, Regenerative loop antenna, Rhombic antenna, Sector antenna, Short backfire antenna, Sloper antenna, Slot antenna, Sterba antenna, Vivaldi antenna, or WokFi Yagi-Uda. In other embodiments the structure illustrated in FIG. 9 antenna can be utilized in an analog, digital, or hybrid domain.

FIG. 9 includes printed circuit board 90, two radiating elements 91a, 91b, and two ground planes 92a, 92b. In the particular embodiment of FIG. 9, the radiating element may be a patch antenna. Ground plane 92a is formed below radiating element 91a, while ground plane 92b is formed below radiating element 91b. In certain embodiments, the radiating elements can be composed of metal, such as copper, or it can be composed of any element, compound, or substrate capable of radiating energy. In certain embodiments, the two ground planes 92a, 92b are either partially of wholly separate. The ground plane may be copper foil, or any other metal, element, compound, or conductive substance.

In certain embodiments, the two ground planes 92a, 92b are connected with two resonators 93a, 93b. As can be seen in the embodiment of FIG. 9, resonators 93a, 93b are each placed between ground plane 92a and ground plane 92b. Resonators 93a, 93b may be composed of any conductive material, element, compound, or substrate. Resonators 93a, 93b, also known as phase shifters, may be made out of lumped components as well. For example, a series resonator, which includes an inductor and a capacitor in series, may form a band pass filter in which the phase, referred to the center frequency of the structure, changes from capacitive to inductive through zero degrees (phase changes from negative 90 degrees to positive 90 degrees). The resonators 93a, 93b can help define the signal phase between the two radiating elements, dedicated to the two ground planes, at a wanted frequency. The resonators thereby improve the beam forming of the antenna, by adjusting the radiated signal interference of the two radiating elements 91a, 91b. The resonator may therefore be used to manipulate the phase and/or the amplitude of the propagated signal.

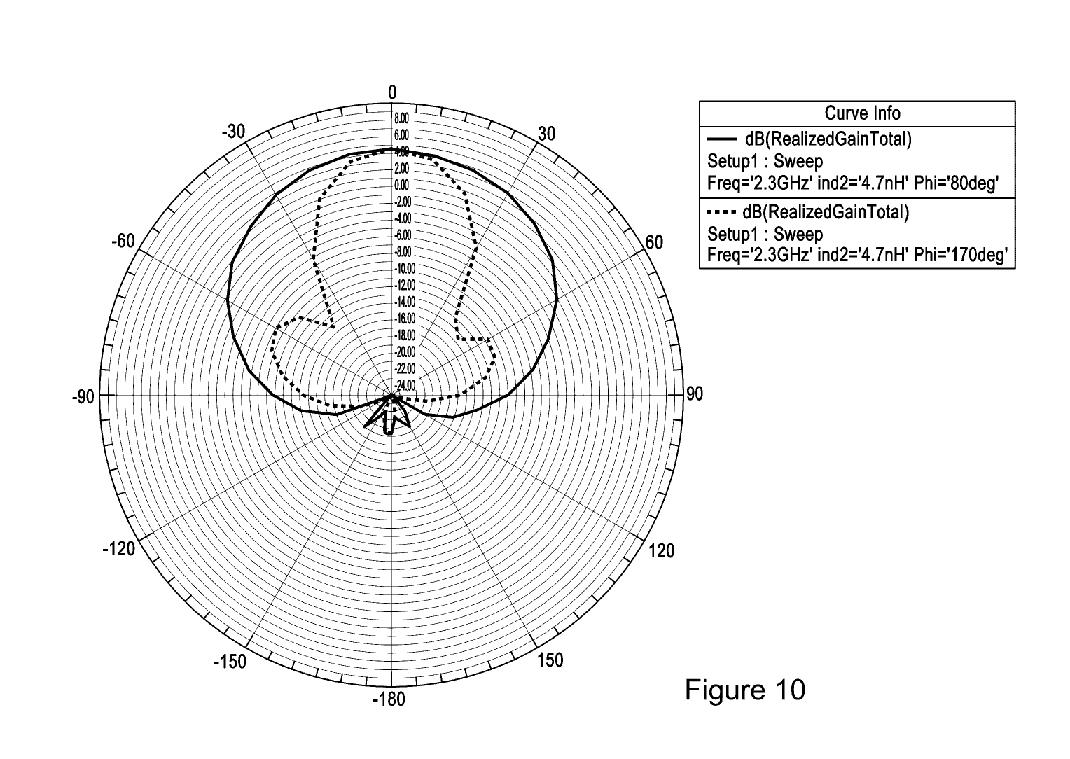

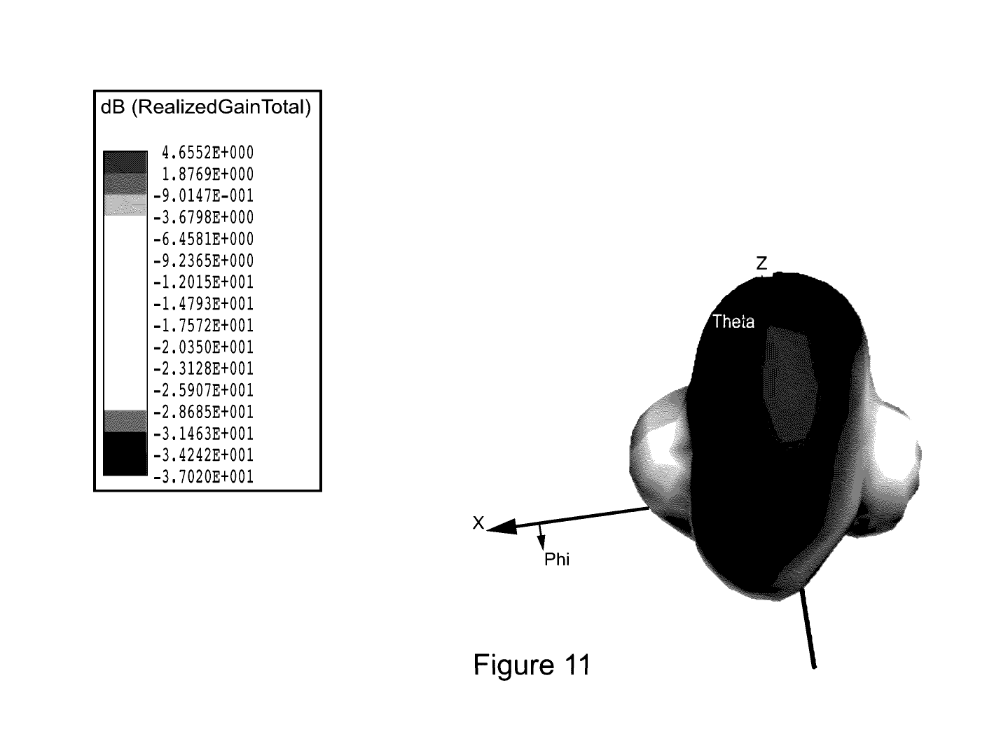

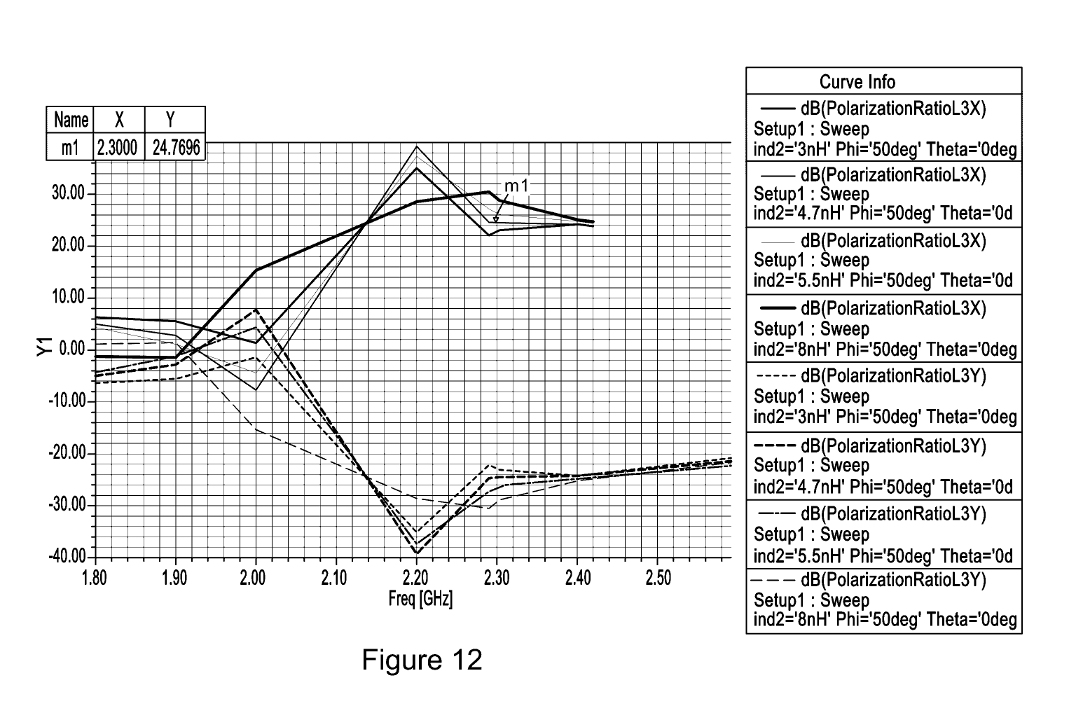

FIGS. 10 and 11 illustrate the total realized gain of the embodiment of the antenna described in FIG. 9. FIG. 12 further illustrates the polarization of the embodiment of the antenna illustrated in FIG. 9. Like previous measurements, the signal phase in FIGS. 10, 11, and 12 is defined in the source and set to be zero degrees. As can be seen in FIG. 10, the total gain of this embodiment is just under 5.00 dBi, and FIG. 11 lists the total gain of this embodiment to be around 4.7 dBi. FIG. 12 illustrates that the polarization of the beam radiated from the antenna of FIG. 9 can be over −30 dBs. The extent of polarization can be adjusted by varying the resonance values. For example, if the resonator is made out of lumped components, the capacitor in the structure can be a varactor component (a reverse biased diode which changes its capacitance value based on the voltage over the pn-junction). The resonance and the phase at certain frequencies are then altered when the voltage over the varactor is changed. The analog antenna embodied in FIG. 9, therefore, improved both the total gain and the polarization of the antennas illustrated in FIGS. 1 and 5, without having to increase the size of the ground plane. In fact, the embodiment of FIG. 9 decreases the surface area of the ground plane, and still manages to improve the gain and polarization of the signal propagated by the antenna.

At least one resonator 93 can connect between ground planes 92a and 92b. In the embodiment shown in FIG. 9, serial resonators 93a, 93b are placed between two separate ground planes 92a, 92b. In certain embodiments, however, only one resonator can be placed between the ground planes. In certain other embodiments, one or more resonators can be used to connect between at least two of the ground planes. In some embodiments, an interface configured to send and/or receive analog signals is connected to at least one of the radiating elements (not shown in the figures).

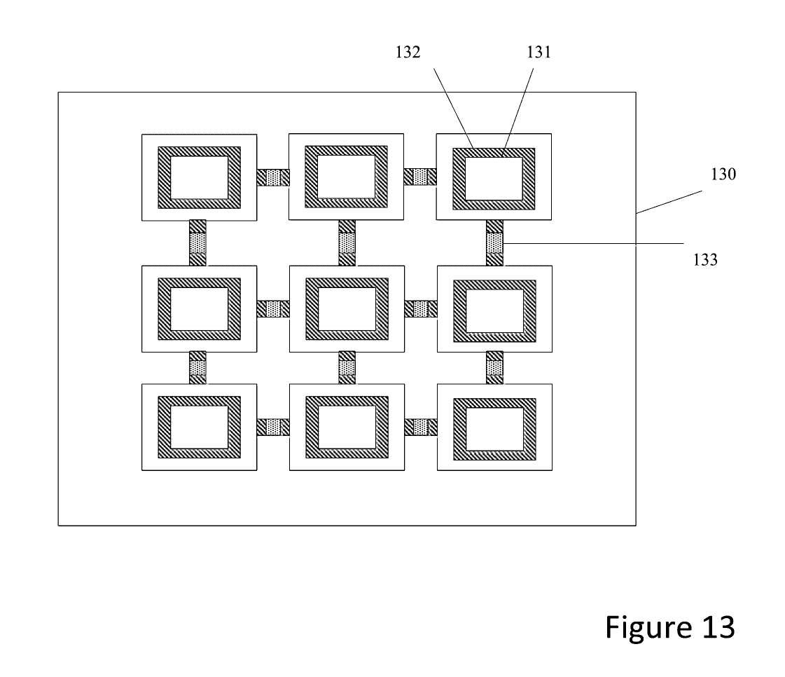

In addition, in certain embodiments, each radiating element is designed with its own separate ground plane. As shown in FIG. 13, a printed circuit board 130 can have nine different ground planes and nine different radiating elements, where each antenna has its own dedicated ground plane. For example, ground plane 132 is designed with the radiating element 131. In some embodiments, radiating element 131 may be connected to ground plane 132. The ground planes on printed circuit board 130 are then connected to one another in two different locations with a resonator 133. In some embodiments, more than two resonators are used to connect the ground planes to each other in at least two different locations. In other embodiments, more than two resonators are used to connect the ground planes in the same location. This means that a single connecting strip between two ground planes may include more than two resonators.

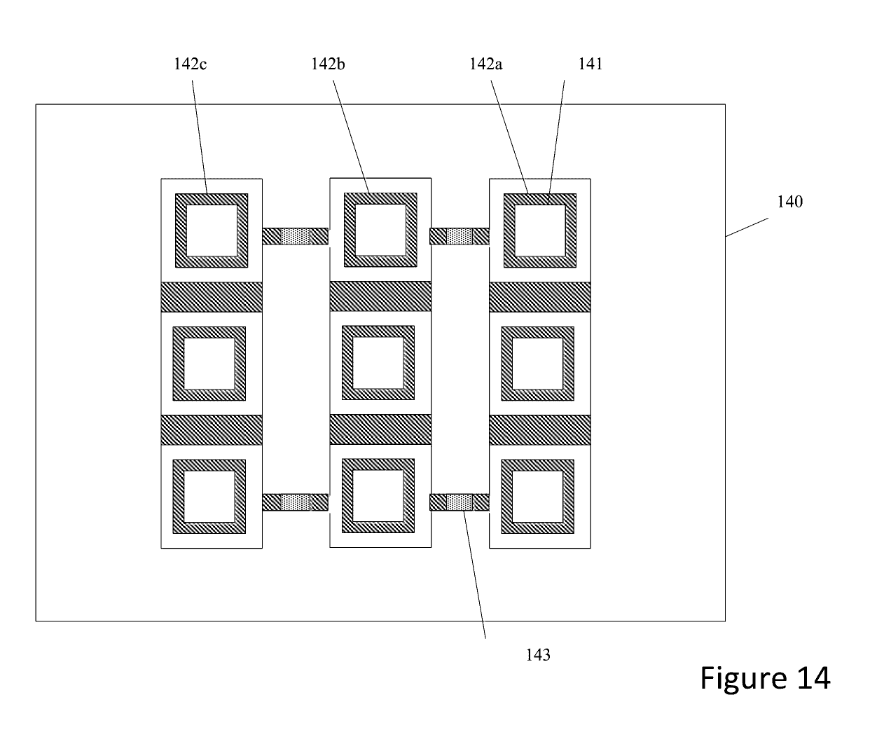

In other embodiments, however, two or more radiating elements can designed with a single ground plane. As shown in FIG. 14, each ground plane can be extended to cover two or more radiating element designs, and the separate ground planes can then be connected to one another with a resonator. For example, printed circuit board 140 contains three different ground planes 142a, 142b, and 142c, each of which is dedicated to three radiating elements. The three radiating elements, therefore, share the same ground plane. In some embodiments, a first subset of radiating elements may be attached to one of the ground planes, and a second subset of the radiating elements may be attached to another of the ground planes. The first and second subsets may each include at least two radiating elements. Resonator 143 may then be placed as a connector between each of the ground planes in two different locations. In other embodiments, only a single resonator connects between each of the ground planes.

Alternatively, not all of the ground planes in an antenna are connected to one another with a resonator. The antenna can contain a first subgroup of at least two ground planes, which are connected to one another with a resonator. The antenna may also include a second subgroup having at least one ground plane which is not connected to other members of the second subgroup with a resonator. At least one ground plane in the second subgroup may or may not have at least one resonator between itself and at least one ground plane of the first subgroup.

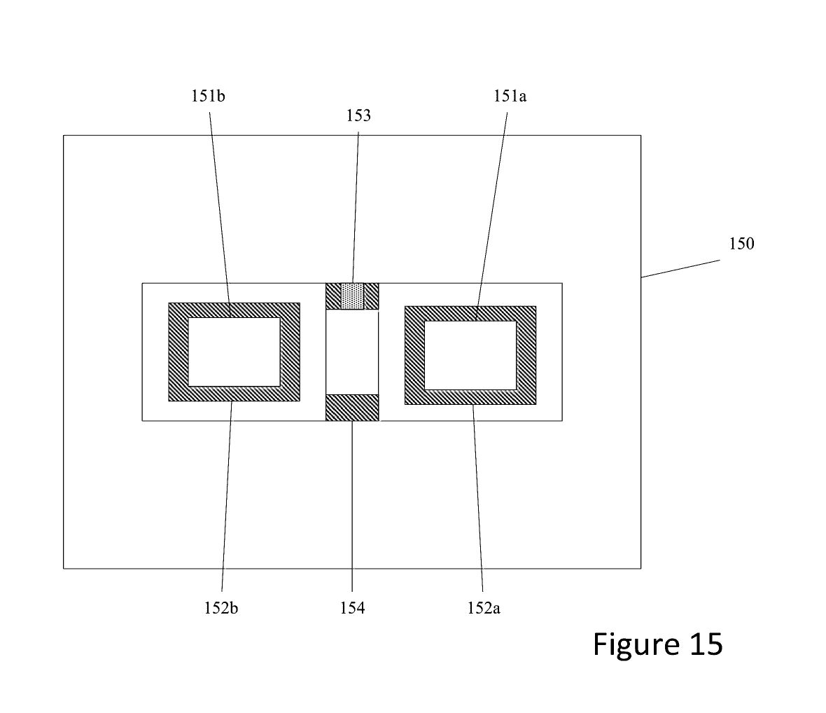

In a further embodiment, as shown in FIG. 15, two ground planes may be at least partially connected to one another without a resonator, and then also have a resonator between the two ground planes. FIG. 15 illustrates a printed circuit board 150, two ground planes 152a, 152b, and two radiating elements 151a, 151b. Ground planes 152a and 152b are already connected by connection point 154. In addition, a resonator 153 is added between ground planes 152a and 152b at a location different than connection point 154. In other embodiments, any connection which utilizes a resonator between two ground planes may be used, as long as the optimum phase and/or amplitude of the signal is achieved.

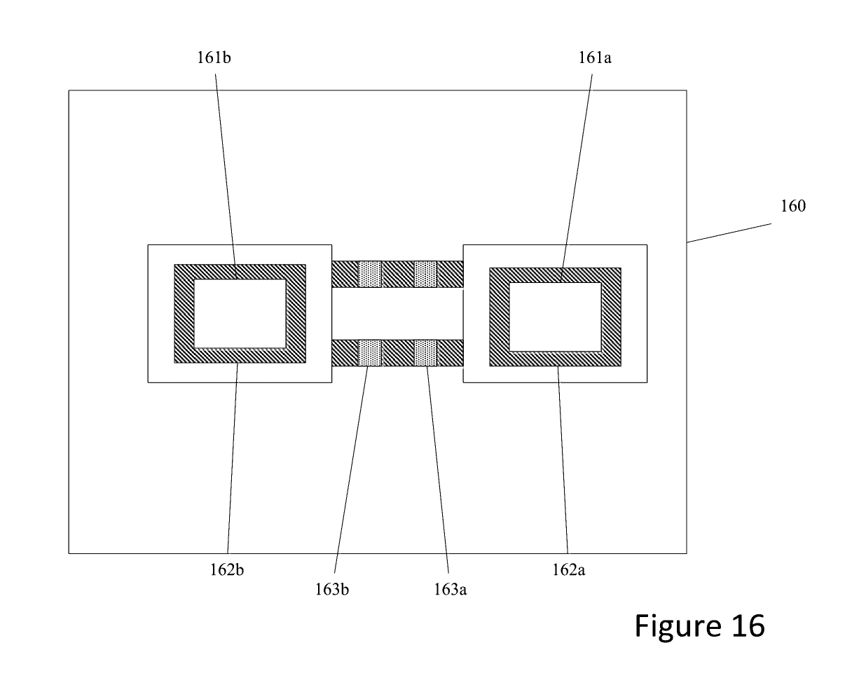

In a different embodiment, shown in FIG. 16, two ground planes can have at least two resonators between them in any one connection strip. When a resonator is connected between two ground planes, a connection strip between the ground planes is created. FIG. 16 illustrate a printed circuit board 160, radiating elements 161a, 161b, and ground planes 162a, 162b. In one of the connection strips between ground planes 162a and 162b, are two different resonators 163a, 163b. Such an embodiment can be used to manipulate the resonance of the phase signal as needed. For example, dual frequency beam forming can be achieved by utilizing at least two resonators on any one connection strip. In order to provide the optimum phase and/or amplitude for two frequencies, one may use multiple phase altering circuits. These circuits may be either in series or in parallel, depending on the wanted optimum phase.

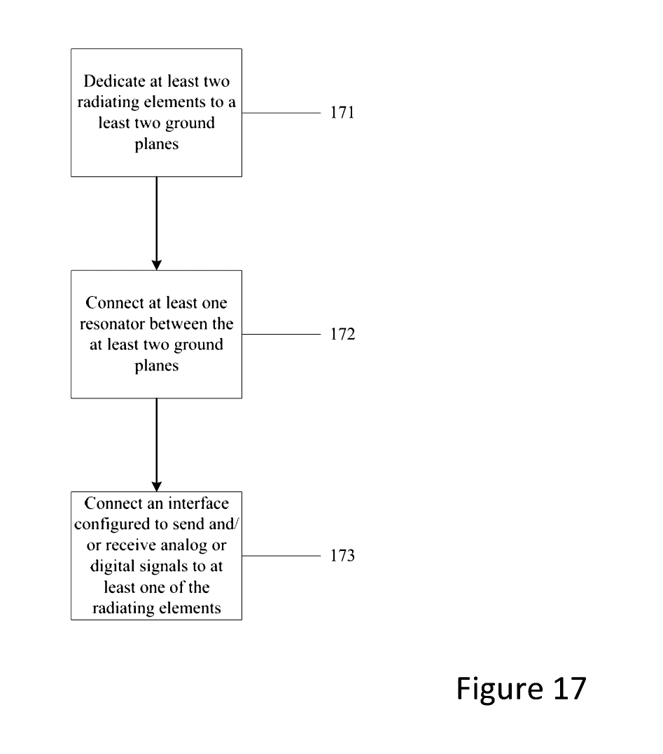

FIG. 17 illustrates a certain embodiment of a method of manufacturing an antenna. In step 171, at least two radiating elements are dedicated to at least two ground planes. At least one resonator can then be connected, in step 172, between the ground planes. In certain other embodiments, an additional step 173 may be taken to connect an interface configured to send and/or receive analog or digital signals to the radiating elements.

The above embodiments allow for a cost effective beam steering structure. Instead of increasing the size of the ground planes to achieve better signal propagation, the size of the ground planes can be minimized to achieve an even greater gain and polarization of the antenna. Certain embodiments utilize at least one resonant to connect at least two ground planes. The resonator manipulates the phase and/or the amplitude of the beamforming signals to optimize beamforming in the multi cell analog array antennas.

The features, structures, or characteristics of certain embodiments described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearance of the phrases “in certain embodiments,” “in some embodiments,” “in other embodiments,” or other similar language, throughout this specification does not necessarily refer to the same group of embodiments, and the described features, structures, or characteristics may be combined in any suitable manner in one or more embodiments.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. Further, although some embodiments of the invention has been described as an analog antenna, certain embodiments of the invention may also be a digital or hybrid antenna.

We claim:

1. An apparatus, comprising:
at least two radiating elements;
at least two ground planes dedicated to the at least two radiating elements; and
at least one resonator, wherein the at least one resonator is connected between the at least two ground planes.

2. The apparatus of claim 1, further comprising: an interface configured to send or receive analog signals, wherein the interface is connected to at least one of the radiating elements.

3. The apparatus of claim 1, further comprising: an interface configured to send or receive digital signals, wherein the interface is connected to at least one of the radiating elements.

4. The apparatus of claim 1, wherein the at least one resonator is configured to define at least one of the phase and the amplitude of a ground signal produced between the at least two radiating elements.

5. The apparatus of claim 1, wherein the radiating element is a patch antenna.

6. The apparatus of claim 1, wherein the at least two ground planes are grounded at different layers.

7. The apparatus of claim 1, wherein the at least two radiating elements are each attached to only one of the at least two ground planes.

8. The apparatus of claim 7, wherein nine of the radiating elements are dedicated to nine of the ground planes, and wherein each ground plane is connected to at least two of the resonators.

9. The apparatus of claim 1, wherein all of the at least two radiating elements are attached to one of the at least two ground planes.

10. The apparatus of claim 1, wherein a first subset of the at least two radiating elements is attached to one of the at least two ground planes, and a second subset of the at least two radiating elements is attached to another of the at least two ground planes,
wherein the first and second subsets each include at least two radiating elements.

11. The apparatus of claim 1, wherein a first subgroup of the at least two ground planes, are connected to one another with a resonator, and a second subgroup having at least one of the ground planes is not connected with a resonator to any other of the at least one ground planes of the second subgroup.

12. The apparatus of claim 11, wherein the at least one resonator connects between at least one of the ground planes in the second subgroup and at least one of the ground planes in the first subgroup.

13. The apparatus of claim 1, wherein one of the at least one resonator connects between the at least two ground planes, and wherein the at least two ground planes are connected at another location.

14. The apparatus of claim 1, further comprising:
at least one connection strip formed when the at least one resonator is connected between the at least two ground planes, wherein at least two resonators can be placed on a single connection strip.

15. A method comprising:
dedicating at least two radiating elements to at least two ground planes; and
connecting at least one resonator between at least two ground planes.

16. The method of claim 15, further comprising:
connecting an interface configured to send or receive analog signals to at least one of the radiating elements.

17. The method of claim 15, wherein the at least one resonator is configured to define the phase between the at least two radiating elements.
